(19) United States
(12) Patent Application Publication
(10) Pub. No.: US 2010/0182266 A1
(43) Pub. Date: Jul. 22, 2010

(54) TOUCH PANEL AND METHOD OF DETECTING PRESS OPERATION POSITION THEREON

(76) Inventor: Koji TANABE, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/685,157

(22) Filed: Jan. 11, 2010

(30) Foreign Application Priority Data
Jan. 19, 2009 (JP) 2009-008582
Apr. 3, 2009 (JP) 2009-091060

(51) Int. Cl. G06F 3/041

(52) U.S. Cl. 345/173

(57) ABSTRACT

In a touch panel, one of conductive layers on a bottom of an upper substrate and on a top of a lower substrate is formed of belt-shaped conductive layers. The other is a single conductive layer facing the belt-shaped conductive layers. The single conductive layer is provided with a pair of electrodes in positions corresponding to both ends in a direction where the belt-shaped conductive layers extend. When the upper substrate is pressed while a voltage is applied between the pair of electrodes, the top and lower conductive layers contact with each other. Then, a voltage value corresponding to the pressed position in the direction where the belt-shaped conductive layers extend is generated from any of the belt-shaped conductive layers. From the voltage value and the position of the belt-shaped conductive layer from which the voltage value is generated, a pressed position on the upper substrate can be detected.

### BACKGROUND OF THE INVENTION

1. Field of the Invention

The present invention relates to a touch panel mainly used for operating various kinds of electronic equipments and a method of detecting a press operation position thereon.

2. Background Art

Recently, various kinds of electronic equipments such as a portable telephone and an electronic camera have advanced in functions and become diversified. Along with this, the number of equipments in which a light-transparent touch panel is mounted on the front surface of a liquid crystal display device or the like is increasing. A user operates by pressing a touch panel with a finger thereof, a pen, or the like, while viewing the indication on a display device at the back of the touch panel. According to this operation, various functions of equipment can be switched from one function to another. Such a conventional touch panel is described with reference to FIG. 8. FIG. 8 is a sectional view showing a conventional touch panel. Note here that the drawing is shown in an enlarged size partially so that the configuration can be understood easily.

This touch panel includes film-shaped light-transparent upper substrate 1, light-transparent lower substrate 2 made of glass or the like, frame-shaped spacer 5 disposed on the inner edge of the outer periphery of upper substrate 1 and lower substrate 2 therebetween. Light-transparent upper conductive layer 3 is formed in a substantially rectangular shape on a substantially entire surface of the bottom surface of upper substrate 1. Light-transparent lower conductive layer 4 is formed on a substantially entire surface of the top surface of lower substrate 2. A plurality of dot spacers (not shown) made of insulating resin are formed on the top surface of lower conductive layer 4 with a predetermined interval. A pair of upper electrodes (not shown) are formed on both ends of upper conductive layer 3, and a pair of lower electrodes (not shown) are formed on both ends of lower conductive layer 4 in the direction perpendicular to the upper electrodes.

On the top and bottom surfaces of spacer 5, an adhesive agent (not shown) is coated. Upper substrate 1 and lower substrate 2 are attached together at their outer peripheries with the adhesive agent. Upper conductive layer 3 and lower conductive layer 4 face each other with a predetermined gap therebetween, and thus the touch panel is formed. The thus formed touch panel is disposed on the front surface of a display device and mounted on electronic equipment. The pairs of the top and lower electrodes are electrically connected to an electronic circuit (not shown) of the equipment.

When a user presses a top surface of upper substrate 1 to operate the touch panel by a finger, a pen, or the like in response to an indication on the display device at the back of the touch panel, upper substrate 1 bends downward, causing upper conductive layer 3 at the pressed place to be brought into contact with lower conductive layer 4. The electronic circuit applies a voltage to the upper electrodes and the lower electrodes sequentially. The electronic circuit detects the pressed place by a ratio of the voltages between the respective pair of electrodes, and thereby switches various functions of equipment.

That is to say, a user presses the top surface of upper substrate 1 in a position on a desired menu in a state in which a plurality of menus, or the like, are displayed on the display device at the back of the touch panel. The electronic circuit detects the operated position by a ratio of the voltage between the upper electrodes and the voltage between the lower electrodes, thereby selecting a desired menu from a plurality of menus.

As mentioned above, the pair of upper electrodes are provided on both ends of the substantially rectangular-shaped upper conductive layer 3 provided on the bottom surface of upper substrate 1. The pair of lower electrodes are provided on both ends in the direction perpendicular to the upper electrodes of similarly substantially rectangular-shaped lower conductive layer 4 on the top surface of lower substrate 2. The electronic circuit detects the pressed place by a ratio of the voltages between the respective pair of electrodes. Therefore, the electronic circuit can detect only one pressed position. For example, when a user presses the position shown by arrow A by one finger and simultaneously presses the position shown by arrow B by another finger, the electronic circuit cannot detect these two pressed positions simultaneously.

In order to detect the pressed positions in such a state, for example, a touch panel has been devised in which upper conductive layer 3 and lower conductive layer 4 are formed of a plurality of conductive layers in a substantially belt shape instead of a substantially rectangular shape and they are allowed to cross in the direction perpendicular to each other and to face each other with a predetermined gap therebetween. By applying a voltage to these conductive layers sequentially, a plurality of pressed positions can be detected. In this case, the formation of a touch panel generally needs several to several tens of conductive layers although it depends on the size of a touch panel.

In the case where a plurality of top and lower conductive layers are provided in this way, several tens of top and lower electrodes are required for the connection from respective conductive layers to an electronic circuit. Therefore, the entire outer shape becomes larger. Moreover, since it is necessary to detect a pressed position by sequentially applying a voltage to all of the electrodes, it takes a long time to detect a position. The connection to an electronic circuit and arithmetic processing for detecting a position become complicated.

### SUMMARY OF THE INVENTION

The present invention provides a touch panel capable of detecting a plurality of pressed positions and capable of carrying out various operations with a simple configuration, and a method of detecting a press operation position on the touch panel.

The touch panel of the present invention includes a light-transparent upper substrate, a light-transparent lower substrate, and a frame-like spacer. An upper conductive layer is formed on a bottom surface of the upper substrate, and a lower conductive layer, facing the upper conductive layer with a predetermined gap therebetween, is formed on a top surface of the lower substrate. The spacer is interposed between the upper substrate and the lower substrate. The touch panel has any one of the following configurations. (1) The upper conductive layer is formed of a plurality of belt-shaped conductive layers. On each end portion of the belt-shaped conductive layers, one of upper electrodes is provided. The lower conductive layer is formed of a single conductive layer facing all of the belt-shaped conductive layers, and is provided with a pair of lower electrodes in positions, which corresponds to both ends in a direction in which the belt-shaped conductive layers extend. (2) The lower conductive layer is formed of a plurality of belt-shaped conductive layers. On each end portion of the belt-shaped conductive layers, one of lower electrodes is provided. The upper conductive layer is formed of a single conductive layer facing all of the plurality of belt-shaped conductive layers, and is provided with a pair of lower electrodes in positions, which correspond to both ends in a direction in which the belt-shaped conductive layers extend.

In the configuration of (1), when the upper substrate is pressed and the upper conductive layer and the lower conductive layer are brought into contact with each other in a state in which a voltage is applied between the pair of lower electrodes, a voltage corresponding to the pressed position in a direction in which the belt-shaped conductive layers extend is generated from any of the belt-shaped conductive layers. Based on this voltage value and the position of the belt-shaped conductive layer where the voltage is detected, the pressed position on the upper substrate is detected.

In the configuration of (2), when the upper substrate is pressed and the upper conductive layer and the lower conductive layer are brought into contact with each other in a state in which a voltage is applied between the pair of upper electrodes, a voltage corresponding to the pressed position in a direction in which the belt-shaped conductive layers extend is generated from any one of the belt-shaped conductive layers. Based on this voltage value and the position of the belt-shaped conductive layer where the voltage is detected, the pressed position of the upper substrate is detected.

That is to say, only by detecting a voltage on the belt-shaped conductive layer, the pressed position can be detected. Moreover, even when a plurality of places are pressed, each of the pressed positions can be detected in a case the pressed positions correspond to different belt-shaped conductive layers. Furthermore, the number of electrodes can be reduced, thus preventing the entire outer shape from being increased. At the same time, connection to an electronic circuit and arithmetic processing for detecting positions can be simplified.

### BRIEF DESCRIPTION OF THE DRAWINGS

FIG. 1 is a sectional view of a touch panel in accordance with an embodiment of the present invention.

FIG. 2 is an exploded perspective view of the touch panel shown in FIG. 1.

FIG. 3 is a diagram showing a connection between the touch panel shown in FIG. 1 and an electronic circuit.

FIG. 4 is a conceptual view in a cross section taken on line 4-4 in FIG. 2.

FIGS. 5A and 5B are plan views showing a state in which the touch panel shown in FIG. 1 is mounted on a display device.

FIGS. 6A and 6B are conceptual views showing a cross section when the touch panel shown in FIG. 4 is pressed for operation.

FIG. 7 is an exploded perspective view of another touch panel in accordance with an embodiment of the present invention.

FIG. 8 is a sectional view of a conventional touch panel.

### DETAILED DESCRIPTION OF THE INVENTION

Hereinafter, an embodiment of the present invention is described with reference to drawings. The drawings are shown in an enlarged size partially so that configurations can be understood easily.

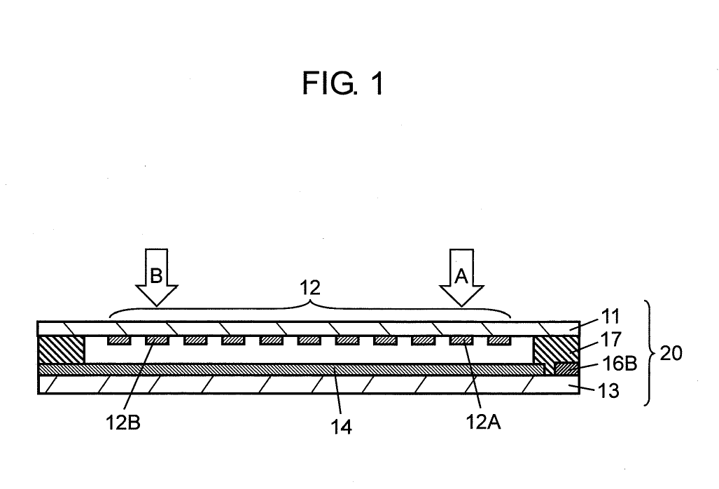

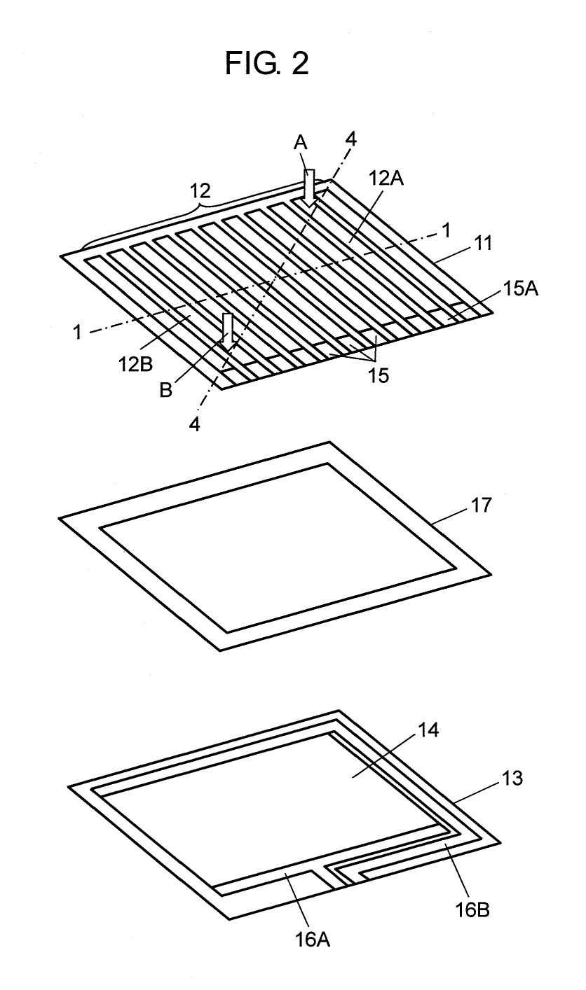

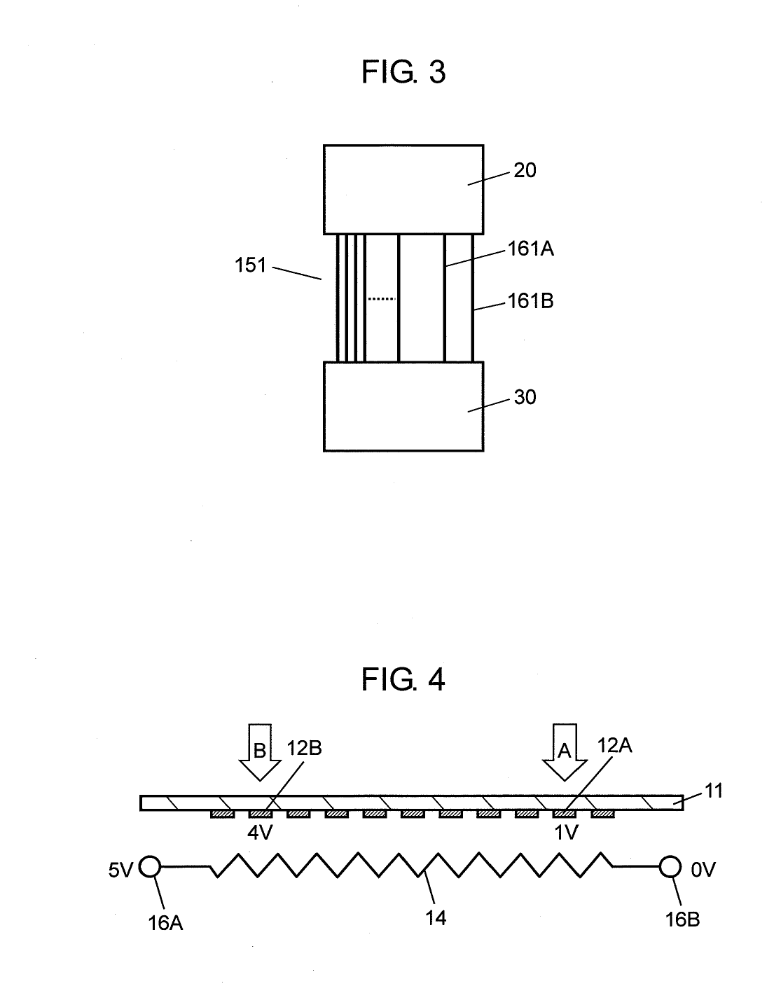

FIGS. 1 and 2 are a sectional view and an exploded perspective view of a touch panel in accordance with an embodiment of the present invention. FIG. 1 shows a cross section taken on line 1-1 shown in FIG. 2. FIG. 3 is a diagram showing a connection between the touch panel and an electronic circuit. FIG. 4 is a conceptual view in a cross section taken on line 4-4 in FIG. 2. Touch panel 20 includes upper substrate 11, lower substrate 13 and spacer 17.

Light-transparent upper substrate 11 is made of light-transparent resin such as polyethylene terephthalate, polyether sulphone, and polycarbonate. Light transparent upper conductive layer 12 made of indium tin oxide, oxide tin, or the like, is formed on the bottom surface of upper substrate 11 by sputtering or the like. Upper conductive layer 12 is formed of belt-shaped conductive layers 12A, 12B and the other belt-shaped conductive layers, each formed in a width of about 0.3-2 mm with an interval of about 0.6-4 mm. On the end portion of each belt-shaped conductive layer, one of upper electrodes 15 made of silver, carbon, or the like, is provided.

Light-transparent lower substrate 13 is made of glass, acrylic, polycarbonate, or the like. Rectangular-shaped light-transparent lower conductive layer 14 made of indium tin oxide, tin oxide, or the like, is formed on the top surface of lower substrate 13 by sputtering or the like. Lower conductive layer 14 is formed of a single conductive layer having a size that faces all of the belt-shaped conductive layers provided on upper substrate 11.

A plurality of dot spacers (not shown) made of insulating resin such as epoxy resin and silicone resin are formed on the top surface of lower conductive layer 14 with a predetermined interval. A pair of lower electrodes 16A and 16B are formed on the front and rear ends of lower conductive layer 14, respectively. That is to say, lower conductive layer 14 is provided with lower electrodes 16A and 16B in positions which correspond to both ends in the direction in which the belt-shaped conductive layers extend.

Spacer 17 is made of polyester, epoxy resin, non-woven fabric, or the like, and is formed in a shape of a frame on the inner edge of the outer periphery between upper substrate 11 and lower substrate 13. An adhesive agent (not shown) such as acrylic agent or rubber agent is coated on either or both of the top and bottom surfaces of spacer 17. With this adhesive agent, upper substrate 11 and lower substrate 13 are attached to each other at their outer peripheries thereof, so that upper conductive layer 12 faces lower conductive layer 14 with a predetermined gap therebetween. That is to say, frame-like spacer 17 is interposed between upper substrate 11 and lower substrate 13.

Thus formed touch panel 20 is disposed on the front surface of, for example, a liquid crystal display device and is mounted on electronic equipment. Upper electrodes 15 and lower electrodes 16A and 16B are electrically connected to electronic circuit 30 of the electronic equipment. Wiring 151 is connected to each of upper electrodes 15 and wirings 161A and 161B are connected to lower electrodes 16A and 16B, respectively.

In the above configuration, a user operates to press a place on the top surface of upper substrate 11, for example, a place shown by arrow A, by a finger, a pen, or the like, in response to the indication on the display device disposed at the back of touch panel 20. According to this operation,, upper substrate 11 bends downward, causing belt-shaped conductive layer 12A of the pressed place to be brought into contact with lower conductive layer 14. At this time, electronic circuit 30 applies a voltage to the both ends of lower conductive layer 14 via lower electrodes 16A and 16B. For example, electric circuit 30 applies a voltage of 5 V between lower electrodes 16A and 16B. In this case, for example, a voltage of 1 V is detected from belt-shaped conductive layer 12A. Based on the voltage value, electric circuit 30 detects a position of arrow A in the front-rear direction. That is to say, electronic circuit 30 detects the pressed position on upper substrate 11 in the direction in which each belt-shaped conductive layer of upper conductive layers 12 extends, based on the voltage value detected from upper electrode 15A among upper electrodes 15.

Furthermore, electronic circuit 30 detects that belt-shaped conductive layer 12A from which the voltage is detected is, for example, the second from the right in upper conductive layer 12. According to this detection, electronic circuit 30 detects the position of arrow A in the right-left direction. That is to say, electronic circuit 30 detects the pressed position on upper substrate 11 in the direction in which the belt-shaped conductive layers are arranged, based on the position of belt-shaped conductive layer 12A connected to upper electrode 15A from which the voltage is detected among upper electrodes 15. In this way, the pressed positions of arrow A in the front-rear direction and in the right-left direction are detected, respectively.

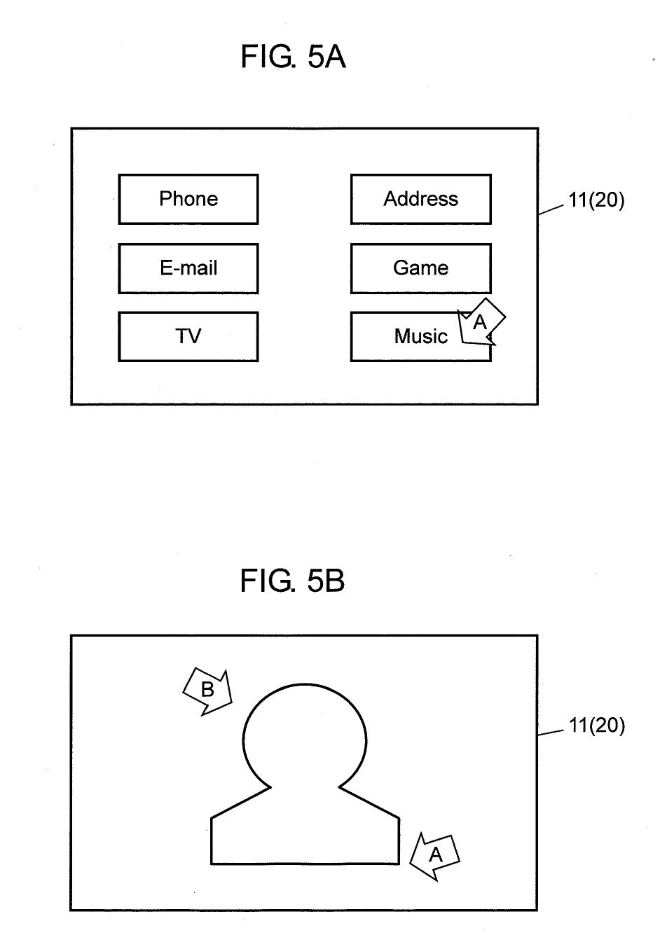

As shown in a plan view of FIG. 5A, in a state in which a plurality of menus are displayed on a display device at the back of touch panel 20, a user presses the top surface of upper substrate 11 on a desired menu. When the user presses a place shown by, for example, arrow A, electronic circuit 30 detects the position in the front-rear direction based on the voltage detected from belt-shaped conductive layer 12A, and detects the position in the right-left direction based on which number belt-shaped conductive layer 12A is. According to this detection, electronic circuit 30 selects a desired menu from the plurality of menus.

Furthermore, as shown in FIG. 5B, in a state in which, for example, a photograph, a map, or the like, is displayed on the display device at the back of touch panel 20, a user presses, for example, a place shown by arrow A on the lower right part. Also in this case, similar to the above-mentioned case, electronic circuit 30 detects the pressed position shown by arrow A. At this time, when the user presses the place shown by arrow B on the upper left part by another finger simultaneously while pressing the place shown by arrow A, the position shown by arrow B also bends downward. For example, as shown in FIGS. 1, 2, and 4, belt-shaped conductive layer 12B corresponding to the thus pressed place is also brought into contact with lower conductive layer 14.

In this case, for example, a voltage of 4V is detected from belt-shaped conductive layer 12B. Therefore, based on this detected voltage, electronic circuit 30 detects the position of arrow B in the front-rear direction. Furthermore, from the fact that belt-shaped conductive layer 12B from which the voltage is detected is, for example, the second from the left in upper conductive layer 12, electronic circuit 30 detects the position in the right-left direction. Thus, in touch panel 20, even when a plurality of positions are pressed, in a case belt-shaped conductive layers that are brought into contact with lower conductive layer 14 are different, each of the pressed positions can be detected.

Furthermore, in this way, while a user presses the lower right place and upper left place of a photograph, map, or the like, the user moves two fingers outward or inward on the diagonal line. In this case, similar to the above-mentioned case, electronic circuit 30 detects the movement of the two pressed positions shown by arrows A and B. Based on this detection, electronic circuit 30 zooms in and out the display of, for example, a photograph or a map on the display device. Such various operations can be carried out.

That is to say, when two places shown by arrows A and B are pressed simultaneously in a state in which, for example, 5 V of voltage is applied to both ends of lower conductive layer 14, for example, 1V of voltage is detected from belt-shaped conductive layer 12A and for example, 4V of voltage is detected from belt-shaped conductive layer 12B. In this way, since detected voltage differs depending upon the difference in the pressed positions in the front-rear direction, electronic circuit 30 can detect a plurality of pressed positions.

As mentioned above, upper conductive layer 12 provided on the bottom surface of upper substrate 11 is formed of a plurality of belt-shaped conductive layers, and belt-shaped conductive layer 12A, 12B, or the like is brought into contact with rectangular-shaped lower conductive layer 14 by a press operation. Then, based on the voltage of belt-shaped conductive layer 12A, 12B, or the like, the position in the front-rear direction is detected. On the other hand, the position in the right-left direction is detected based on which number belt-shaped conductive layer 12A or 12B is. Thus, a plurality of pressed positions can be detected. Furthermore, the number of wirings 151, 161A, and 161B to be connected to electronic circuit 30 can be reduced. The number of wirings 151 at the upper substrate 11 side is several tens, which is the same as that of the belt-shaped conductive layers, and the number of wirings 161A and 161B at the lower substrate 13 side is only two. Therefore, it is possible to prevent the entire outer shape from being increased and to simplify connection to electronic circuit 30 and arithmetic processing for detection of positions. Various operations can be carried out with such a simple configuration.

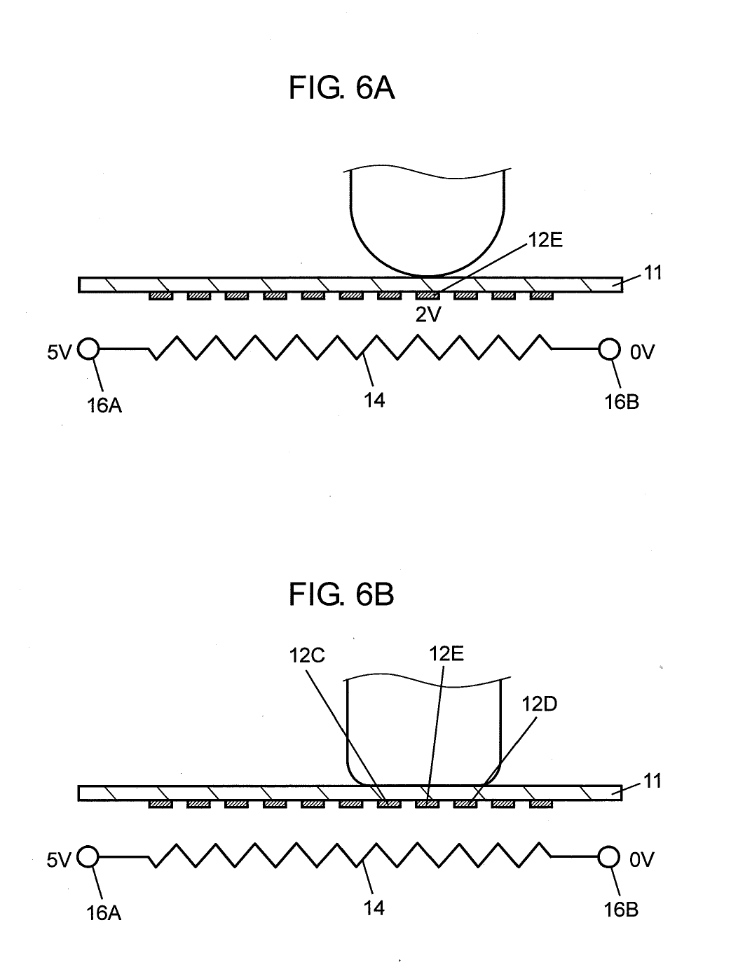

Furthermore, the following detection can be also carried out by using touch panel 20. Firstly, as shown in the conceptual sectional view shown in FIG. 6A, a user presses the top surface of upper substrate 11 by slightly touching the top surface by a finger. In this case, upper substrate 11 bends downward, causing only belt-shaped conductive layer 12E in the pressed place to be brought into contact with lower conductive layer 14. In a state in which, for example, 5V of voltage is applied to between lower electrode 16A and lower electrode 16B, for example, 2 V of voltage is detected from belt-shaped conductive layer 12E.

When the user further presses the top surface of the upper substrate 11 strongly by a finger with force added, the contact area of the finger is increased and upper substrate 11 bends larger as shown in FIG. 6B. Therefore, a part that is brought into contact with lower conductive layer 14 of belt-shaped conductive layer 12E is expanded in the front-rear direction, thus causing belt-shaped conductive layers 12C and 12D to be brought into contact with lower conductive layer 14. As a result, a voltage is detected also from belt-shaped conductive layers 12C and 12D.

That is to say, since upper conductive layer 12 on the bottom surface of upper substrate 11 is formed of a plurality of belt-shaped conductive layers, the number of belt-shaped conductive layers that are brought into contact with lower conductive layer 14 differ according to whether the case in which the top surface of upper substrate 11 is operated by slightly touching the top surface by a finger or the case in which the surface is operated to be pressed strongly.

Therefore, for example, as shown in FIG. 5A, when touch panel 20 is slightly touched in a state in which a plurality of menus or the like are displayed on the display device, the next menu is displayed, for example. When touch panel 20 is strongly touched, the selected menu is determined. Such various operations can be carried out.

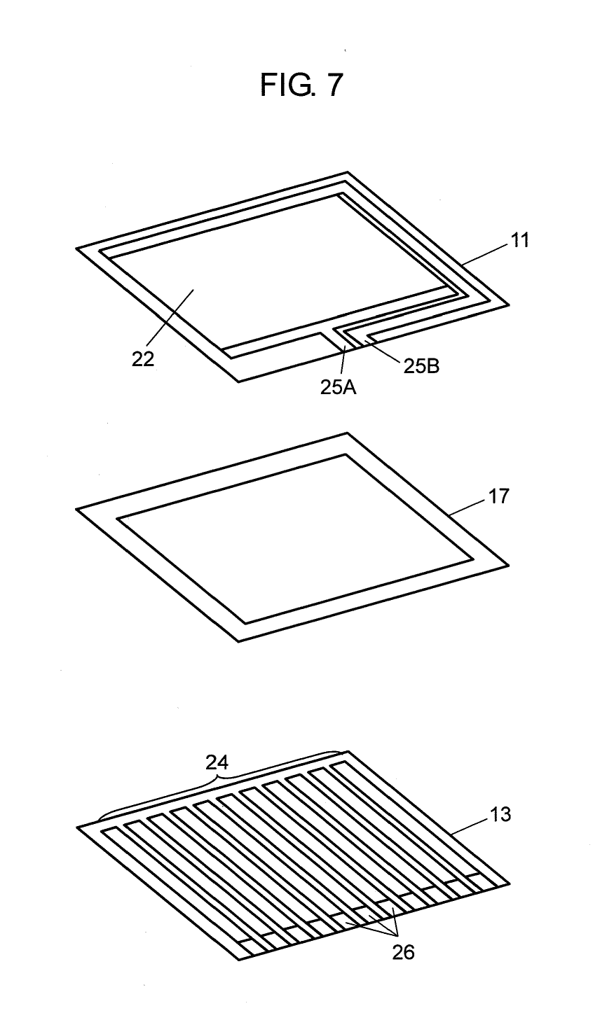

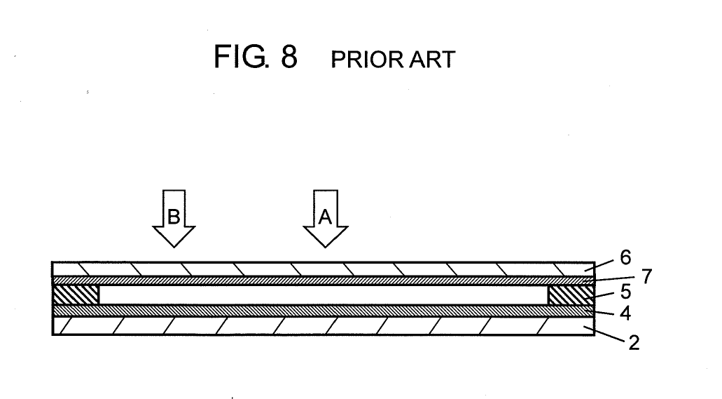

In the above description, a configuration in which upper conductive layer 12 on the bottom surface of upper substrate 11 is formed of a plurality of belt-shaped conductive layers is described. Besides, as shown in an exploded perspective view of FIG. 7, upper conductive layer 22 may be formed in a rectangular shape, and lower conductive layer 24 on the top surface of lower substrate 13 may be formed of a plurality of belt-shaped conductive layers. In this case, one of lower electrodes 26 is provided on each end portion of a plurality of belt-shaped conductive layers, and upper conductive layer 22 is formed of a single conductive layer facing all of the belt-shaped conductive layers. Then, upper conductive layer 22 is provided with a pair of upper electrodes 25A and 25B in positions which correspond to both ends in the direction in which the belt-shaped conductive layers extend. Also in such a configuration, the same effect can be obtained as that of touch panel 20 shown in FIGS. 1 and 2.

That is to say, electronic circuit 30 applies a voltage between upper electrodes 25A and 25B, and then detects a voltage on each of lower electrodes 26. Furthermore, electronic circuit 30 detects a pressed position on upper substrate 11 in the direction in which the belt-shaped conductive layers are arranged, based on the position on the belt-shaped conductive layer connected to the lower electrode from which the voltage is detected among lower electrodes 26. On the other hand, electronic circuit 30 detects a pressed position on upper substrate 11 in the direction in which the belt-shaped conductive layer extends, based on the voltage value detected from the lower electrode from which the voltage is detected among lower electrodes 26.

Thus, in this embodiment, upper conductive layer 12 on the bottom surface of upper substrate 11 is formed of a plurality of belt-shaped conductive layers, and lower conductive layer 14 as a counterpart to upper conductive layer 12 is formed of a single conductive layer facing all of the plurality of belt-shaped conductive layers. Alternatively, lower conductive layer 24 on the top surface of lower substrate 13 is formed of a plurality of belt-shaped conductive layers and upper conductive layer 22 as a counterpart to lower conductive layer 24 is formed of a single conductive layer facing all of the plurality of belt-shaped conductive layers. With either one of the configurations, only by detecting a voltage from any one of upper conductive layer 12 and lower conductive layer 24 formed of a plurality of belt-shaped conductive layers, a plurality of the pressed positions can be detected. Therefore, the number of upper electrodes 15, lower electrodes 16A and 16B, or upper electrodes 25A and 25B and lower electrodes 26 can be reduced. It is possible to prevent the entire outer shape from being increased. Furthermore, it is possible to simplify connection to electronic circuit 30 and arithmetic processing for detection of positions. It is possible to manufacture a touch panel capable of detecting a plurality of pressed positions and capable of carrying out various operations with a simple configuration.

As mentioned above, by using a touch panel with a simple configuration according to the present invention, a plurality of pressed positions can be detected, and various operations can be carried out. This touch panel is useful mainly for operating various electronic equipments.

What is claimed is:

1. A touch panel comprising:
a light-transparent upper substrate provided with an upper conductive layer on a bottom surface thereof;
a light-transparent lower substrate provided with a lower conductive layer on a top surface thereof, the lower conductive layer facing the upper conductive layer with a predetermined gap therebetween; and
a frame-like spacer interposed between the upper substrate and the lower substrate;
wherein the touch panel has any one of following configurations:
A) the upper conductive layer is formed of a plurality of belt-shaped conductive layers, each of the belt-shaped conductive layers is provided with one of upper electrodes on an end portion thereof, the lower conductive layer is formed of a single conductive layer facing all of the belt-shaped conductive layers and is provided with a pair of lower electrodes in positions which correspond to both ends in a direction in which the belt-shaped conductive layers extend; and
B) the lower conductive layer is formed of a plurality of belt-shaped conductive layers, each of the belt-shaped conductive layers is provided with one of lower electrodes on an end portion thereof, and the upper conductive layer is formed of a single conductive layer facing all of the plurality of belt-shaped conductive layers and is provided with a pair of upper electrodes in positions which correspond to both ends in a direction in which the belt-shaped conductive layers extend.

2. A method of detecting a press operation position on an upper substrate of a touch panel,
the touch panel comprising:
the light-transparent upper substrate provided with an upper conductive layer on a bottom surface thereof;
a light-transparent lower substrate provided with a lower conductive layer on a top surface thereof, the lower conductive layer facing the upper conductive layer with a predetermined gap therebetween; and
a frame-like spacer interposed between the upper substrate and the lower substrate;
wherein the upper conductive layer is formed of a plurality of belt-shaped conductive layers, each of the belt-shaped conductive layers is provided with one of upper electrodes on an end portion thereof, the lower conductive layer is formed of a single conductive layer facing all of the belt-shaped conductive layers and is provided with a pair of lower electrodes in positions which correspond to both ends in a direction in which the belt-shaped conductive layers extend, the method comprising:
applying a voltage between the pair of lower electrodes;
detecting respective voltage values at the upper electrodes;
detecting a pressed position on the upper substrate in a direction in which the belt-shaped conductive layers are arranged, based on a position of one of the belt-shaped conductive layers connected to one of the upper electrodes from which a voltage value is detected; and
detecting a pressed position on the upper substrate in a direction in which the belt-shaped conductive layers extend, based on the voltage value detected from the one of the upper electrodes.

3. A method of detecting a press operation position on an upper substrate of a touch panel,
the touch panel comprising:
the light-transparent upper substrate provided with an upper conductive layer on a bottom surface thereof;
a light-transparent lower substrate provided with a lower conductive layer on a top surface thereof, the lower conductive layer facing the upper conductive layer with a predetermined gap therebetween; and
a frame-like spacer interposed between the upper substrate and the lower substrate;
wherein the lower conductive layer is formed of a plurality of belt-shaped conductive layers, each of the belt-shaped conductive layers is provided with one of lower electrodes on an end portion thereof, and the upper conductive layer is formed of a single conductive layer facing all of the plurality of belt-shaped conductive layers and is provided with a pair of upper electrodes in positions which correspond to both ends in a direction in which the belt-shaped conductive layers extend
the method comprising:
applying a voltage between the pair of upper electrodes;
detecting respective voltage values at the lower electrodes;
detecting a pressed position on the upper substrate in a direction in which the belt-shaped conductive layers are arranged, based on a position of one of the belt-shaped conductive layers connected to one of the lower electrodes from which a voltage value is detected; and
detecting a pressed position on the upper substrate in a direction in which the belt-shaped conductive layers extend, based on the voltage value detected from the one of the lower electrodes.
